(19) United States
(12) Patent Application Publication
(10) Pub. No.: US 2014/0265931 A1
(43) Pub. Date: Sep. 18, 2014

(54) Electrical Power Supply With Removable Plug-In Cartridge

(71) Applicant: Simon Richard Greenwood, Cheshire (GB)

(72) Inventor: Simon Richard Greenwood, Cheshire (GB)

(73) Assignee: Hatch Transformers, Inc., Tampa, FL (US)

(21) Appl. No.: 13/838,251

(22) Filed: Mar. 15, 2013

(51) Int. Cl. G05F 1/10; H05B 37/02

(52) U.S. Cl. CPC G05F 1/10; H05B 37/02
USPC 315/307; 323/318

(57) ABSTRACT

A power supply for supplying electrical power at a predetermined level is provided. The power supply includes circuitry configured to receive an electrical input and produce an electrical output. The power supply further includes a housing with an opening configured to receive a removable plug-in cartridge. The removable plug-in cartridge is configured to limit the electrical power output to the predetermined level.

### FIELD OF THE INVENTION

This invention generally relates to electrical power supplies, and more particularly to power supplies for LED lighting systems.

### BACKGROUND OF THE INVENTION

Typically, conventional power supplies are designed to provide an electrical output at a predetermined current level or at a predetermined voltage or power level. These power supplies generally include a circuitry to provide the aforementioned power, current and/or voltage levels sealed within a housing. In some cases, this circuitry is not designed to be modified and therefore is not accessible to the user. If the user requires electrical power at a variety of voltage and current levels, a separate power supply might need to be purchased for each voltage and current level desired. As such, users may be forced acquire a number of different power supplies at considerable expense.

In other cases, the power supply includes multiple wires that require measuring and selecting the appropriate wires for use in a circuit. Other power supplies have jumpers on a circuit board, or a dip switch for selecting a desired output level. These systems are error-prone and could easily result in the wrong output voltage or current being selected by the user.

Embodiments of the present invention address the aforementioned problems and represent an advancement over the current state of the art with respect to electrical power supplies. Certain advantages of the invention, as well as various inventive features thereof, will be apparent from the description of the invention provided herein.

### BRIEF SUMMARY OF THE INVENTION

In one aspect, embodiments of the invention provide a power supply that supplies electrical power at a predetermined level. The power supply includes circuitry configured to receive an electrical input and produce an electrical output. The power supply further includes a housing with an opening configured to receive a removable plug-in cartridge. The removable plug-in cartridge is configured to limit the electrical power output to the predetermined level. In particular embodiments, the power supply is configured to supply power to a light-emitting diode (LED) lighting system, a compact fluorescent (CFL) lighting system, or a high-intensity discharge (HID) lighting system. Further, the power supply may be configured to supply electrical power in a range from 1 watt to 100 watts, and accommodate electrical inputs ranging from 90 volts to 300 volts.

In a particular embodiment, the removable plug-in cartridge limits the power, current, or voltage output of the power supply to a predetermined current level. The removable plug-in cartridge may include a resistive or other element, or may have circuitry designed to output a constant current or voltage or power or required function of voltage and current regardless of the voltage of the electrical input.

In certain embodiments, the removable plug-in cartridge is marked with a current value, and the plug-in cartridge is configured to limit the current level of the electrical output to the current value, while in other embodiments, the removable plug-in cartridge is marked with a voltage value, and the plug-in cartridge is configured to limit the voltage level of the electrical output to the voltage value. In yet other embodiments, the removable plug-in cartridge is marked with a power value, and the plug-in cartridge is configured to limit the power level of the electrical output to the power value. The removable plug-in cartridge may also include other function-indicative coding and/or color coding to indicate function or performance of the power supply.

In an embodiment of the invention, the removable plug-in cartridge is configured to interrupt a flow path between one or more beams light sources and one or more respective photodiodes, wherein the pattern of light detected by the photodiodes determines a current or voltage value, power, or function of the electrical output. Alternatively, the circuitry and the removable plug-in cartridge may include corresponding inductively-coupled or magnetically-coupled elements, wherein a parameter of the inductively-coupled elements determines a current, voltage, power, or other functional value of the electrical output. The inductively-coupled or magnetically-coupled elements may include some combination of magnetic components and reed switches, or, in alternate embodiments, may include a Hall Effect device or other magnetic-field-sensitive device.

In a further embodiment, the circuitry for the power supply includes two connectors, and wherein the removable plug-in cartridge has two electrical terminals, each designed to be inserted into a respective one of the two connectors.

In another aspect, embodiments of the invention provide an LED driver for providing electrical power to an LED lighting unit. The LED driver includes circuitry configured to receive an electrical input and produce an electrical output. The LED driver further includes a housing with an opening configured to receive a removable plug-in cartridge. The removable plug-in cartridge is configured to limit the electrical power output to the predetermined level. Alternate embodiments of the invention include CFL and HID ballast circuits configured to provide power for either CFL or HID lighting systems.

The LED driver may be configured as a constant-current LED driver, as a constant-voltage LED driver, a constant power LED driver, or an LED driver configured to deliver some other function of voltage and current to an LED. Similarly, the CFL and/or HID ballasts may be configured to deliver constant current, constant voltage, constant power, or some other function of voltage and current.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an power supply for LED lighting, constructed in accordance with an embodiment of the invention;

FIG. 2 is an exploded view of the power supply of FIG. 1; and

FIG. 3 is a perspective view of an LED driver with a section of the housing removed, constructed in accordance with an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

While embodiments of the present invention are described herein with respect to their use in Light-Emitting Diode (LED), compact fluorescent light (CFL), and high-intensity discharge (HID) lighting systems, one of skill in the art will recognize that the invention is not necessarily limited to this type of application. Nothing disclosed herein is intended to limit the invention to use with LED, CFL, or HID lighting systems. It is envisioned that the subject matter of this application may find uses in other types of lighting systems, or in any number of applications where electrical power is desired at a constant current or constant voltage.

Power supplies for the aforementioned lighting systems, also referred to as LED drivers, CFL ballasts, or HID ballasts may provide AC power or DC power depending on the design of the lighting system. DC lighting system power supplies may be configured to supply either constant current or constant voltage. For example, constant-current LED drivers are typically used to drive a group of LEDs wired in series, while constant-voltage LED drivers are typically used to drive a group of LEDs wired in parallel. The power output of these power supplies may vary widely. For example, systems that provide electrical power from 1 watt to 100 watts are typical. Further, these systems may be capable of accepting a wide range of input voltages, for example from 90 volts to over 300 volts.

FIGS. 1 and 2 illustrate a perspective view of a power supply 100 that may provide electrical power for HID, CFL, or LED lighting, or for any number of other electrical devices, and an exploded view of the power supply 100 of FIG. 1, respectively. The power supply 100 has input terminals 102 to receive an electrical input and circuitry 106 to generate an electrical output on output terminals 104. The circuitry 106 is contained within a housing 108, which has an opening 110 configured to receive a removable plug-in cartridge 112. The housing 108 made be made from metal or from plastic, depending on the application. The opening 110 may be a slotted or rectangular opening, as shown in FIGS. 1 and 2, sized to provide a snug fit for the removable plug-in cartridge 112.

However, the embodiment of FIG. 3 shows the metal housing 108 with an insert 114 inserted into the opening 110. The insert 114 may be made from rubber, plastic, or a similarly suitable material, and serves to protect the removable plug-in cartridge 112 from damage by the edges of the metal housing. The insert 114 may also extend downward to the circuitry 106 of the power supply 100 and serve as a guide for insertion of the removable plug-in cartridge 112.

In certain embodiments, the removable plug-in cartridge 112 is configured to limit the current output from a constant current power supply to a predetermined current level, or in alternate embodiments, configured to limit the voltage output from a constant voltage power supply to a predetermined level of voltage, power, or function of voltage and current. The removable plug-in cartridge 112 may be a resistive element, or may have circuitry configured to output a constant current despite fluctuations in the voltage of the electrical input. Alternatively, the removable plug-in cartridge 112 may have circuitry configured to output a voltage despite fluctuations in the voltage of the electrical input.

In a particular embodiment, the circuitry 106 includes two receptacles 118, and the removable plug-in cartridge 112 includes two terminals 116, each designed for insertion into a respective one of the two mating receptacles 118. As can be seen from FIGS. 1-3, the removable plug-in cartridge 112 includes visible marking 120, which shows the output current for a constant current power supply 100, or, alternatively, shows the output voltage for a constant voltage power supply 100.

Thus, a user can fashion a power supply to provide any number of desired output currents, voltages, power, or function of voltage and current by merely swapping out the removable plug-in cartridge 112 for one with the desired current, voltage, power, or function rating. As such, one power supply can satisfy a wide range of user needs. Also, because the current, voltage, power, or function to be output by the power supply is clearly shown, via text or color coding for example, on the plug-in cartridge, user-caused errors are less likely.

In another embodiment of the invention, the power supply 100 includes a non-contact means for selecting power supply output current, or output voltage, such as, but not limited to, the interruption of a beam of light from an LED to a receiving photodiode such that the power supply 100 mechanically interrupts or passes the beam causing a signal current or no-signal current to flow in the receiving photodiode, depending on the presence or non-presence of an interruptor to the beam of light from the LED. In an exemplary embodiment, a multiplicity of pairs of LEDs and photodiodes, incorporated in the circuitry 106, can be arranged to coincide with possible light paths, which may be arranged so as to interrupt or allow the passage of light between the LED and the photodiode. The removable plug-in cartridge 112 may be configured to interrupt light beams in the manner described. In such an arrangement of pairs of LEDs and photodiodes, the electrical signal from the photodiode can be decoded, in at least one instance, as a binary number such that certain binary numbers correspond to certain power supply 100 output currents, voltages, power, or function or voltage and current.

In alternate embodiments, other non-contact means for selecting power supply 100 output current or voltage are also envisioned. These include, but are not limited to, power supplies 100 in which the removable plug-in cartridge 112 includes some combination of magnetic parts with reed switches or Hall Effect devices arranged to encode power supply 100 output currents or voltages, and non-contact means having inductively-coupled elements where a parameter of the inductively-coupled elements is read and may correspond to a particular driver output current or voltage of the power supply 100. It should be noted that other non-contact means for selecting or adjusting power supply 100 output current or voltage not mentioned here are not excluded from the invention.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A power supply that provides electrical power at a predetermined level, the power supply comprising:
circuitry configured to receive an electrical input and produce an electrical output;
a housing having an opening configured to receive a removable plug-in cartridge configured to limit the electrical power output to the predetermined level.

2. The power supply of claim 1, wherein the removable plug-in cartridge limits the current output of the power supply to a predetermined current level.

3. The power supply of claim 2, further comprising the removable plug-in cartridge marked with a current value, wherein the removable plug-in cartridge is configured to limit the current level of the electrical output to the current value.

4. The power supply of claim 2, wherein the removable plug-in cartridge comprises circuitry designed to output a constant current despite fluctuations in the voltage and current levels of the electrical input.

5. The power supply of claim 1, wherein the removable plug-in cartridge limits the voltage output of the power supply to a predetermined voltage level.

6. The power supply of claim 5, further comprising the removable plug-in cartridge marked with a voltage value, wherein the removable plug-in cartridge is configured to limit the voltage level of the electrical output to the voltage value.

7. The power supply of claim 5, wherein the removable plug-in cartridge comprises circuitry designed to output a constant voltage despite fluctuations in the voltage and current levels of the electrical input.

8. The power supply of claim 1, wherein the circuitry includes two connectors, and wherein the removable plug-in cartridge has two electrical terminals, each designed to be inserted into a respective one of the two connectors.

9. The power supply of claim 8, wherein the removable plug-in cartridge comprises a resistive element.

10. The power supply of claim 8, configured to supply power for one of an LED lighting system, a CFL lighting system, and an HID lighting system.

11. The power supply of claim 1, wherein the electrical power output of the power supply ranges from 1 watt to 100 watts.

12. The power supply of claim 11, wherein the electrical input accommodated by the power supply ranges from 90 volts to 300 volts.

13. The power supply of claim 1, wherein the removable plug-in cartridge is configured to interrupt a flow path between one or more beams light sources and one or more respective photodiodes, wherein the pattern of light detected by the photodiodes determines a current or voltage value of the electrical output.

14. The power supply of claim 1, wherein the circuitry and the removable plug-in cartridge include corresponding inductively-coupled elements, wherein a parameter of the inductively-coupled elements determines a current or voltage value of the electrical output.

15. The power supply of claim 14, wherein the inductively-coupled elements include some combination of magnetic components and reed switches.

16. The power supply of claim 14, wherein the inductively-coupled elements include a Hall Effect device.

17. An apparatus for supplying electrical power, the apparatus comprising:
circuitry configured to receive an electrical input and generate an electrical output for one of an LED lighting system, a CFL lighting system, and an HID lighting system;
a housing having an opening configured to receive a removable plug-in cartridge configured to limit the electrical power output to the predetermined level.

18. The apparatus of claim 17 configured as a constant-current power source.

19. The apparatus of claim 17 configured as a constant-voltage power source.

20. The apparatus of claim 17, wherein the removable plug-in cartridge either limits the current output of the power supply to a predetermined current level, or limits the voltage output of the power supply to a predetermined voltage level.

21. The apparatus of claim 20, wherein the removable plug-in cartridge comprises circuitry designed either to output a constant current despite fluctuations in the voltage and current levels of the electrical input, or to output a constant voltage despite fluctuations in the voltage and current levels of the electrical input.

22. The apparatus of claim 17, wherein the removable plug-in cartridge is a resistive element.

23. The apparatus of claim 17, wherein the circuitry includes two connectors, and the removable plug-in cartridge has two electrical terminals, each designed to be inserted into a respective one of the two connectors, and wherein the removable plug-in cartridge is either marked with a current value such that the removable plug-in cartridge is configured to limit the current level of the electrical output to the current value, or marked with a voltage value such that the removable plug-in cartridge is configured to limit the voltage level of the electrical output to the voltage value.

24. The apparatus of claim 17, wherein the electrical power output of the power supply ranges from 1 watt to 100 watts, and the electrical input accommodated by the power supply ranges from 90 volts to 300 volts.

25. The apparatus of claim 17, wherein the removable plug-in cartridge is configured to interrupt a flow path between one or more beams light sources and one or more respective photodiodes, wherein the pattern of light detected by the photodiodes determines a current or voltage value of the electrical output.

26. The apparatus of claim 17, wherein the removable plug-in cartridge wherein the circuitry and the removable plug-in cartridge include corresponding inductively-coupled elements such that a parameter of the inductively-coupled elements determines a current or voltage value of the electrical output, and wherein the inductively-coupled elements include either some combination of magnetic components and reed switches, or one or more Hall Effect devices.
